(19) United States
(12) Patent Application Publication
(10) Pub. No.: US 2018/0363725 A1
(43) Pub. Date: Dec. 20, 2018

(54) MAGNETO-RHEOLOGICAL FLUID DAMPER

(71) Applicant: KYB Corporation, Tokyo (JP)

(72) Inventor: Yasuhiro YONEHARA, Kanagawa (JP)

(73) Assignee: KYB Corporation, Tokyo (JP)

(21) Appl. No.: 16/060,490

(22) PCT Filed: Sep. 9, 2016
(86) PCT No.: PCT/JP2016/076679

§ 371 Date: Jun. 8, 2018

(30) Foreign Application Priority Data
Jan. 12, 2016 (JP) 2016-003838

(51) Int. Cl. F16F 9/53; F16F 9/32

(52) U.S. Cl. CPC F16F 9/535; F16F 2224/045; F16F 2222/06; F16F 9/3214

(57) ABSTRACT

A damper includes a coil that generates a magnetic field acting on magneto-rheological fluid flowing through a communication passage. A piston includes a concave portion formed on an outer peripheral surface of a piston core, a regulating member housed in the concave portion, an introduction flow passage that guides the magneto-rheological fluid in a first fluid chamber or a second fluid chamber into the concave portion such that the regulating member projects into the communication passage, and a fail valve that opens and closes the introduction flow passage. In the case where a current applied to the coil is a predetermined value or less, the regulating member projects into the communication passage.

### TECHNICAL FIELD

The present invention relates to a magneto-rheological fluid damper.

### BACKGROUND ART

JP2009-216210A discloses a damping force variable type damper that includes a cylinder filled with magneto-rheological fluid, a piston where a flow passage to cause the magneto-rheological fluid to flow between a one-side liquid chamber and an other side liquid chamber is formed, and coils disposed in the piston. A magnetic field, which is generated by flowing a current into the coils, is applied to the magneto-rheological fluid passing through the flow passage to control a damping force. With the damping force variable damper of JP2009-216210A, when the magneto-rheological fluid passes through a clearance between an inner yoke and an outer yoke, energizing the coils causes a strong flow passage resistance by the magnetic field formed in the clearance, generating the high damping force.

### SUMMARY OF INVENTION

The damping force variable damper described in JP2009-216210A controls the current energized to the coils to adjust the damping force. However, for example, when the coils are disconnected and this results in a failure of a flow of the current to the coils, the damping force cannot be generated. This allows generating only a minimum damping force generated when the magneto-rheological fluid passes through the clearance between the inner yoke and the outer yoke. Such minimum damping force damps vibrations, possibly causing an inconvenience such as taking time.

An object of the present invention is to provide a magneto-rheological fluid damper that can obtain a certain damping force even if a coil cannot generate a predetermined damping force.

According to an aspect of the present invention, a magneto-rheological fluid damper that employs magneto-rheological fluid as working fluid, the magneto-rheological fluid changing viscosity in accordance with a strength of a magnetic field, the magneto-rheological fluid damper includes: a cylinder into which the magneto-rheological fluid is sealed; a piston coupled to a piston rod, the piston being movably disposed in the cylinder; and a first fluid chamber and a second fluid chamber partitioned in the cylinder by the piston. The piston includes: a piston core coupled to the piston rod; a ring body that surrounds an outer periphery of the piston core, a communication passage being formed between the piston core and the ring body, the communication passage communicating between the first fluid chamber and the second fluid chamber; an electromagnetic coil configured to generate a magnetic field acting on the magneto-rheological fluid flowing through the communication passage; a concave portion formed on an outer peripheral surface of the piston core; a regulating member housed in the concave portion; an introduction flow passage that guides the magneto-rheological fluid in the first fluid chamber or the second fluid chamber into the concave portion such that the regulating member projects into the communication passage; and a fail valve that opens and closes the introduction flow passage. In a case where a current applied to the electromagnetic coil has a predetermined value or less, opening the introduction flow passage by the fail valve projects the regulating member into the communication passage.

### BRIEF DESCRIPTION OF DRAWINGS

FIG. 1 is a cross-sectional view of a magneto-rheological fluid damper in an axis direction according to an embodiment of the present invention.

FIG. 2 is a left side view of a piston in FIG. 1.

FIG. 3 is a cross-sectional view of a regulating member in a radial direction according to the embodiment of the present invention.

FIG. 4 is an enlarged view around a fail valve in FIG. 2.

FIG. 5 is an enlarged view around a fail valve according to a modification.

### DESCRIPTION OF EMBODIMENTS

The following describes an embodiment of the present invention with reference to the drawings.

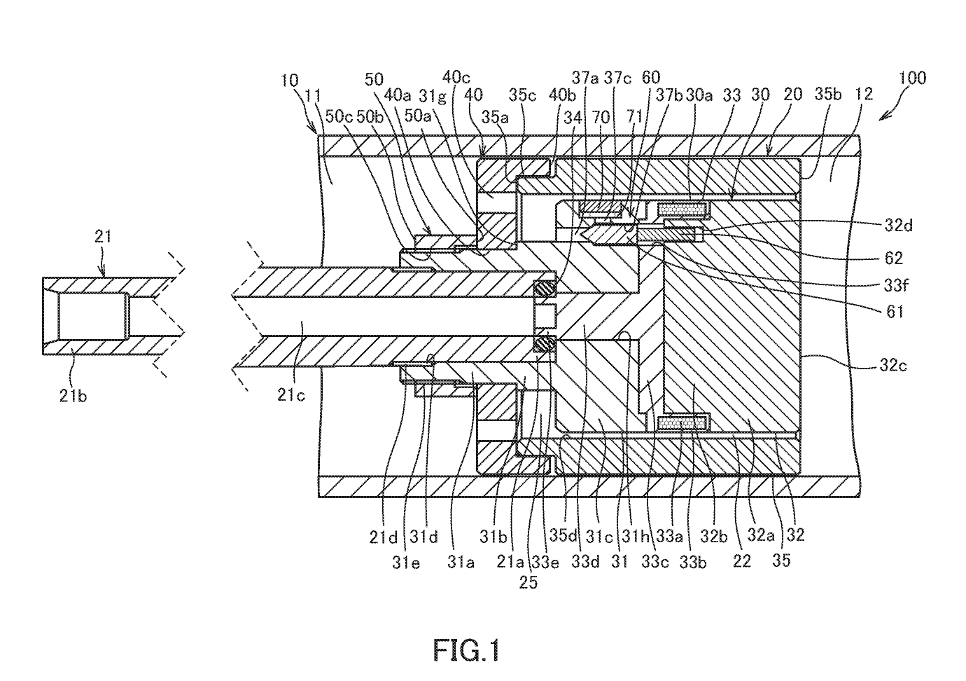

First, the following describes an overall configuration of a magneto-rheological fluid damper (hereinafter simply referred to as a “damper”) 100 according to the embodiment of the present invention with reference to FIG. 1.

The damper 100 is a damper that can change an attenuation coefficient by the use of magneto-rheological fluid, which changes viscosity according to an action of a magnetic field. The damper 100 is, for example, interposed between a vehicle body and a wheel shaft in a vehicle such as an automobile. The damper 100 generates the damping force that reduces vibrations of the vehicle body through extension and contraction.

The damper 100 includes a cylinder 10 that internally seals the magneto-rheological fluid, a piston rod 21 that extends to an outside of the cylinder 10, and a piston 20. The piston 20 is coupled to the piston rod 21 and slidably disposed in the cylinder 10. In association with a movement of the piston 20, the piston rod 21 advances and retreats with respect to the cylinder 10.

The cylinder 10 is formed into a closed-bottomed cylindrical shape. The magneto-rheological fluid sealed in the cylinder 10 changes apparent viscosity by an action of a magnetic field. The magneto-rheological fluid is liquid produced by dispersing microparticles with ferromagnetism in liquid such as an oil. The viscosity of the magneto-rheological fluid changes in accordance with a strength of the magnetic field acting on the magneto-rheological fluid. When the magneto-rheological fluid is free from the influence of the magnetic field, the magneto-rheological fluid returns to an original state.

A gas chamber (not illustrated) to seal gas is defined via a free piston (not illustrated) in the cylinder 10. The gas chamber compensates a volume change in the cylinder 10 by advance and retreat of the piston rod 21.

The piston 20 partitions a first fluid chamber 11 and a second fluid chamber 12 in the cylinder 10. The piston 20 includes a ring-shaped communication passage 22 configured to allow the magneto-rheological fluid to flow between the first fluid chamber 11 and the second fluid chamber 12. Details of a configuration of the piston 20 will be described later.

The piston rod 21 is formed coaxially with the piston 20. A one-end 21a of the piston rod 21 is fixed to the piston 20, and an other end 21b extends to the outside of the cylinder 10.

The piston rod 21 has a cylindrical shape where a through-hole 21c is formed from the one-end 21a to the other end 21b. A male screw 21d screwed with the piston 20 is formed on an outer peripheral surface of the piston rod 21.

The following describes a configuration of the piston 20 with reference to FIG. 1 to FIG. 4.

The piston 20 includes a piston core 30 coupled to the piston rod 21, a ring-shaped flux ring 35, a ring-shaped plate 40, and a fixing nut 50. The flux ring 35 as a ring body surrounds an outer periphery of the piston core 30. The plate 40 is disposed at the piston core 30 and supports the flux ring 35. The fixing nut 50 is mounted to an outer peripheral surface of the piston core 30 and fixes the plate 40 to the piston core 30.

The piston core 30 dividedly includes a coil assembly 33, which includes a coil 33a, and a first core 31 and a second core 32 that sandwich the coil assembly 33. While sandwiching the coil assembly 33, the first core 31 and the second core 32 are tightened with a pair of bolts (not illustrated).

The first core 31 includes a cylindrical first small-diameter portion 31a, a cylindrical second small-diameter portion 31b, and a cylindrical large-diameter portion 31c. The second small-diameter portion 31b is formed to have a diameter larger than that of the first small-diameter portion 31a. The large-diameter portion 31c is formed to have a diameter larger than that of the second small-diameter portion 31b. The first core 31 is made of a magnetic material.

A female screw 31d screwed with the male screw 21d of the piston rod 21 is formed on an inner peripheral surface of the first small-diameter portion 31a. The screwing of the female screw 31d of the first small-diameter portion 31a with the male screw 21d of the piston rod 21 tightens the first core 31 to the piston rod 21. A male screw 31e screwed with the fixing nut 50 is formed on an outer peripheral surface at a distal end of the first small-diameter portion 31a.

The second small-diameter portion 31b is formed concentrically and continuously with the first small-diameter portion 31a in an axis direction. A stepped portion 31g is formed between the first small-diameter portion 31a and the second small-diameter portion 31b. An inside of an end surface of the plate 40 abuts on the stepped portion 31g to sandwich the plate 40 between the stepped portion 31g and the fixing nut 50.

The large-diameter portion 31c is formed concentrically with the second small-diameter portion 31b in the axis direction and abuts on the coil assembly 33.

The second core 32 of the piston core 30 includes a column-shaped large-diameter portion 32a and a column-shaped small-diameter portion 32b formed to have a diameter smaller than that of the large-diameter portion 32a. The large-diameter portion 32a includes an end surface 32c that fronts onto the second fluid chamber 12. The small-diameter portion 32b is formed concentrically and continuously with the large-diameter portion 32a in the axis direction. Similar to the first core 31, the second core 32 is made of the magnetic material.

The coil assembly 33 of the piston core 30 includes a cylindrical coil mold portion 33b, which internally includes the coil 33a, a coupling portion 33c, and a column portion 33d. The coupling portion 33c extends from one end of the coil mold portion 33b to radially inside. The column portion 33d axially extends from the coupling portion 33c. The coil assembly 33 is formed by molding a resin with the coil 33a inserted.

An inner diameter of the coil mold portion 33b is formed to have a diameter approximately identical to an outer diameter of the small-diameter portion 32b of the second core 32 and fits to an outer peripheral surface of the small-diameter portion 32b. The first core 31 and the second core 32 sandwich the coil mold portion 33b and the coupling portion 33c.

The column portion 33d is positioned on a side opposite to the coil mold portion 33b with respect to the coupling portion 33c. An outer diameter of the column portion 33d is formed to have a diameter approximately identical to an inner diameter of a through-hole 31h formed on the large-diameter portion 31c and fits to the through-hole 31h.

A distal end portion 33e of the column portion 33d is inserted into the through-hole 21c of the piston rod 21. An O-ring 34 is disposed on an outer peripheral side of the distal end portion 33e of the column portion 33d.

The O-ring 34 is axially compressed by the large-diameter portion 31c of the first core 31 and the piston rod 21 and is radially compressed by the distal end portion 33e of the coil assembly 33 and the piston rod 21. This prevents a leakage of the magneto-rheological fluid from between the piston rod 21 and the first core 31 and between the first core 31 and the coil assembly 33 to the through-hole 21c on the piston rod 21.

Thus, the piston core 30 dividedly includes the three members, the first core 31, the second core 32, and the coil assembly 33. Accordingly, it is only necessary to only form the coil assembly 33 that includes the coil 33a by molding, and the first core 31 and the second core 32 sandwich the coil assembly 33. The piston core 30, which is dividedly formed into the three members, ensures easily forming the piston core 30 compared with the case where the piston core 30 alone is formed and molding work is performed.

In the piston core 30, while screwing the female screw 31d with the male screw 21d fixes the first core 31 to the piston rod 21, the coil assembly 33 and the second core 32 are only axially fitted. The use of the pair of bolts fixes the second core 32 and the coil assembly 33 so as to be pressed to the first core 31. This allows easy assembly of the piston core 30.

Outer diameters of the large-diameter portion 32a of the second core 32 and the coil mold portion 33b are formed to have diameters identical to that of the large-diameter portion 31c of the first core 31. The outer diameters of the large-diameter portion 31c of the first core 31, the large-diameter portion 32a of the second core 32, and the coil mold portion 33b are identical. Therefore, the following refers to a part constituted of the large-diameter portion 31c of the first core 31, the large-diameter portion 32a of the second core 32, and the coil mold portion 33b as a “large-diameter portion 30a” of the piston core 30.

The flux ring 35 of the piston 20 is formed to be an approximately cylindrical shape with the magnetic material. The flux ring 35 is formed to have an outer diameter approximately identical to an inner diameter of the cylinder 10. The flux ring 35 is formed to have an inner diameter larger than that of an outer diameter of the large-diameter portion 30a of the piston core 30. Accordingly, a ring-shaped clearance is formed between an inner peripheral surface 35d of the flux ring 35 and an outer peripheral surface of the large-diameter portion 30a of the piston core 30 across an axial overall length. This clearance functions as a communication passage 22 through which the magneto-rheological fluid flows.

The flux ring 35 includes a small-diameter portion 35c at a one-end 35a. The plate 40 is fitted to the small-diameter portion 35c. The small-diameter portion 35c is formed to have a diameter smaller than those of other parts of the flux ring 35 such that the plate 40 is fitted to the outer periphery.

The coil mold portion 33b fronts onto the communication passage 22. Therefore, the magnetic field generated by the coil 33a acts on the magneto-rheological fluid flowing through the communication passage 22. That is, the communication passage 22 functions as a magnetic gap through which magnetic flux generated around the coil 33a passes.

The coil 33a forms the magnetic field by a current supplied from the outside. A strength of this magnetic field strengthens as the current supplied to the coil 33a increases. When the current is supplied to the coil 33a and the magnetic field is formed, the apparent viscosity of the magneto-rheological fluid flowing through the communication passage 22 changes. The viscosity of the magneto-rheological fluid increases as the magnetic field by the coil 33a strengthens.

A pair of wirings (not illustrated) to supply the coil 33a with the current are routed at the inside of the coupling portion 33c and the column portion 33d. The pair of wirings are extracted from a distal end of the column portion 33d and are passed through the through-hole 21c on the piston rod 21.

The plate 40 supports the one-end 35a of the flux ring 35 with respect to the piston core 30 so as to define an axial position of the flux ring 35. An outer periphery of the plate 40 is formed to have a diameter identical to or equal to or smaller than an outer periphery of the flux ring 35. The plate 40 is made of a non-magnetic material.

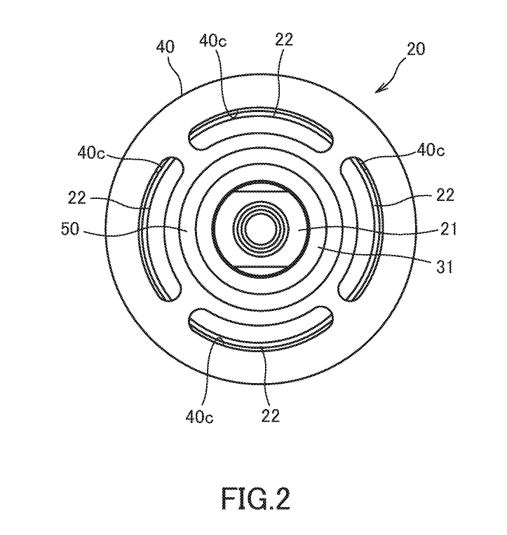

As illustrated in FIG. 1 and FIG. 2, the plate 40 includes a plurality of flow passages 40c, which are through-holes communicating with the communication passage 22. The flow passages 40c are formed into an arc shape and are disposed at equal angular intervals. In the embodiment, the flow passages 40c are formed at four positions at intervals of 90°. The flow passages 40c are not limited to be the arc shape but may be, for example, a plurality of circular through-holes.

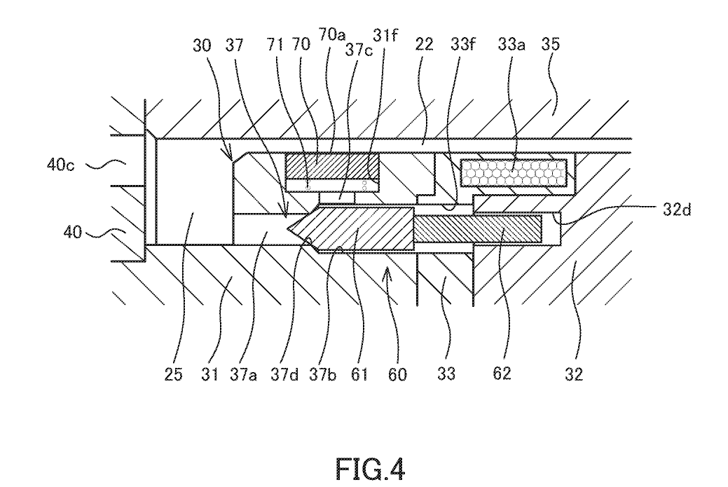

As illustrated in FIG. 1 and FIG. 4, a coupling space 25 to couple the flow passages 40c and the communication passage 22 is formed between the plate 40 and the large-diameter portion 31c of the first core 31. The coupling space 25 is a ring-shaped space formed at an outer periphery of the second small-diameter portion 31b. The magneto-rheological fluid flown from the flow passages 40c into the piston core 30 flows to the communication passage 22 via the coupling space 25. Thus, the flow passages 40c, the coupling space 25, and the communication passage 22 communicate between the first fluid chamber 11 and the second fluid chamber 12.

A through-hole 40a to which the first small-diameter portion 31a of the first core 31 fits is formed at an inner periphery of the plate 40. Fitting the through-hole 40a to the first small-diameter portion 31a secures coaxiality of the plate 40 with the first core 31 (piston core 30).

A ring-shaped collar portion 40b to fit to the small-diameter portion 35c of the one-end 35a of the flux ring 35 is formed at an outer periphery of the plate 40. The collar portion 40b is formed axially projecting to the flux ring 35. The collar portion 40b is fixed to the small-diameter portion 35c by brazing.

A tightening power by the fixing nut 50 to the first small-diameter portion 31a of the first core 31 presses the plate 40 to a stepped portion 30d to be sandwiched. This defines an axial position of the flux ring 35 fixed to the plate 40 with respect to the piston core 30.

The fixing nut 50 is formed into an approximately cylindrical shape and is mounted to an outer periphery of the first small-diameter portion 31a of the piston core 30. A distal end portion 50a of the fixing nut 50 abuts on the plate 40. A female screw 50c screwed with the male screw 31e of the first core 31 is formed on an inner periphery of a base end portion 50b of the fixing nut 50. This screws the fixing nut 50 with the first small-diameter portion 31a.

As described above, the plate 40, which is mounted to the one-end 35a of the flux ring 35, is sandwiched between the stepped portion 30d of the piston core 30 mounted to an end portion of the piston rod 21 and the fixing nut 50 screwed with the first small-diameter portion 31a. This axially fixes the flux ring 35 to the piston core 30.

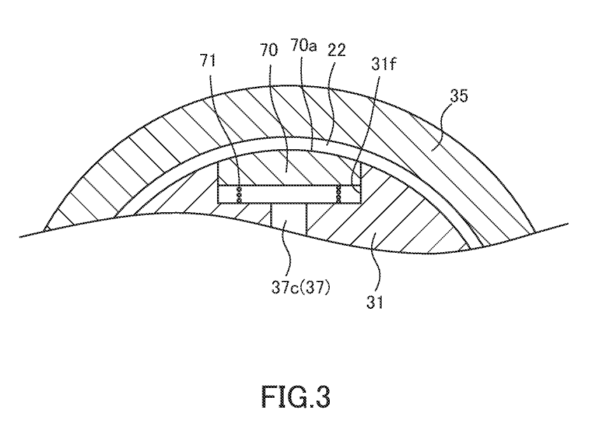

As illustrated in FIG. 3 and FIG. 4, the piston 20 further includes a concave portion 31f, which is formed on an outer peripheral surface of the piston core 30, a regulating member 70 housed in the concave portion 31f, an introduction flow passage 37, and a fail valve 60 to open and close the introduction flow passage 37. The introduction flow passage 37 guides the magneto-rheological fluid in the first fluid chamber 11 into the concave portion 31f such that the regulating member 70 projects into the communication passage 22.

As illustrated in FIG. 3, the concave portion 31f is formed into a groove shape circumferentially extending in a certain range in an outer peripheral surface of the first core 31. Side surfaces of the concave portion 31f opposed in an axis direction and a radial direction are formed to be parallel to one another.

The regulating member 70 is formed to be fitted into the concave portion 31f leaving a slight clearance. This prevents the magneto-rheological fluid from leaking between the regulating member 70 and the concave portion 31f. An external surface 70a of the regulating member 70 fronting onto the communication passage 22 is formed to have a curvature identical to an outer peripheral surface of the first core 31 (see FIG. 3).

A spring 71 is disposed between the regulating member 70 and a bottom portion of the concave portion 31f. When the regulating member 70 is positioned at a position to be a flat surface with the outer peripheral surface of the first core 31, the spring 71 is configured to have a natural length. Accordingly, even if the regulating member 70 is pushed into the concave portion 31f, a biasing force by the spring 71 pushes the regulating member 70 back to a position where the external surface 70a forms the flat surface with the outer peripheral surface of the first core 31.

As illustrated in FIG. 4, the introduction flow passage 37 includes a first introduction flow passage 37a, a housing hole 37b, and a second introduction flow passage 37c. The first introduction flow passage 37a communicates with the coupling space 25 and axially extends in the first core 31. The housing hole 37b communicates with the first introduction flow passage 37a and includes a valve element 61, which will be described later, of the fail valve 60. The second introduction flow passage 37c communicates between the housing hole 37b and the concave portion 31f. The housing hole 37b is formed concentrically with the first introduction flow passage 37a and is formed to have a diameter larger than that of the first introduction flow passage 37a. A valve seat 37d is disposed at a boundary between the first introduction flow passage 37a and the housing hole 37b. The second introduction flow passage 37c is formed perpendicular to the housing hole 37b.

The fail valve 60 includes the valve element 61 and a movable core 62. The valve element 61 is disposed in the housing hole 37b to open or close the introduction flow passage 37. The variable core 62 is coupled to the valve element 61 and moves in accordance with the magnetic force generated by the coil 33a. The valve element 61 is formed into a cone shape such that the distal end portion can be seated on the valve seat 37d. The valve element 61 is movably housed in a space formed by the housing hole 37b and a through-hole 33f. The through-hole 33f is formed so as to pass through the coupling portion 33c of the coil assembly 33 continuous with the housing hole 37b. The movable core 62 is movably housed in a space formed by the through-hole 33f and an insertion hole 32d formed concentrically with the through-hole 33f in the second core 32. It should be noted that, the valve element 61 and the movable core 62 may be integrally formed.

The following describes operations of the fail valve 60 thus configured.

In the case where the current flowing through the coil 33a is a predetermined value Ia or more, the magnetic force generated by the coil 33a biases the movable core 62 to the valve seat 37d direction, and the valve element 61, which is coupled to the movable core 62, is pressed to the valve seat 37d. This closes the introduction flow passage 37 by the fail valve 60, cutting off the flow of the magneto-rheological fluid from the coupling space 25 to the concave portion 31f. It should be noted that, the predetermined value Ia of the current is a current value at which, when the damper 100 performs an expansion operation and a pressure of the first fluid chamber 11 becomes high, even if this high pressure acts on the valve element 61 from the coupling space 25 through the first introduction flow passage 37a, the biasing force of ensuring maintaining a value-close state of the valve element 61 is generated.

In contrast to this, in the case where the current flowing through the coil 33a is the predetermined value Ia or less, the magnetic force generated by the coil 33a weakens. The biasing force that the movable core 62 biases the valve element 61 to the valve seat 37d direction also decreases by the amount. Accordingly, when the damper 100 performs the expansion operation and the pressure of the first fluid chamber 11 becomes high, this high pressure acts on the valve element 61 from the coupling space 25 through the first introduction flow passage 37a. Then, the valve element 61 separates from the valve seat 37d. This opens the introduction flow passage 37 by the fail valve 60 to allow the flow of the magneto-rheological fluid from the coupling space 25 to the concave portion 31f.

The following describes actions of the damper 100 thus configured.

When the damper 100 extends and contracts and the piston rod 21 advances and retreats with respect to the cylinder 10, the piston 20 coupled to the piston rod 21 slides inside the cylinder 10. Accordingly, the magneto-rheological fluid flows from the first fluid chamber 11 and the second fluid chamber 12 and vice versa through the flow passages 40c, the coupling space 25, and the communication passage 22.

As described above, at this time, the communication passage 22 between the piston core 30 and the flux ring 35 serves as the magnetic gap through which the magnetic flux generated around the coil 33a passes. This causes the magnetic field by the coil 33a to act on the magneto-rheological fluid flowing through the communication passage 22 during the extension and contraction of the damper 100.

The damping force generated by the damper 100 is adjusted by changing an amount of energization to the coil 33a and changing the strength of the magnetic field acting on the magneto-rheological fluid flowing through the communication passage 22. Specifically, as the current supplied to the coil 33a increases, the strength of the magnetic field generated around the coil 33a increases. This increases the viscosity of the magneto-rheological fluid flowing through the communication passage 22, increasing the damping force generated by the damper 100.

The current at the predetermined value Ia or more is always applied to the coil 33a in normal operation of the damper 100. In view of this, the biasing force of always pressing the valve element 61 to the valve seat 37d is generated by the magnetic force generated by the coil 33a in the movable core 62 of the fail valve 60, and the introduction flow passage 37 is maintained to be the close state.

For example, the use of the damper 100 possibly fails to apply the current to the coil 33a due to the disconnection and a failure of a control device or a similar device. Alternatively, due to some sort of reasons, the current applied to the coil 33a possibly decreases. In the damper 100 with such failure, the coil 33a cannot generate the magnetic force or the magnetic force generated by the coil 33a is reduced. In such state, when the expansion operation of the damper 100 increases the pressure of the magneto-rheological fluid in the first fluid chamber 11, this high pressure flows from the coupling space 25 into the first introduction flow passage 37a and acts on the valve element 61. Accordingly, the high-pressure magneto-rheological fluid flown into the first introduction flow passage 37a presses the valve element 61 in a value-open direction to separate the valve element 61 from the valve seat 37d. This opens the introduction flow passage 37 and the coupling space 25 communicates with the concave portion 31f.

The opening of the introduction flow passage 37 causes the magneto-rheological fluid in the first fluid chamber 11 to flow into the concave portion 31f through the coupling space 25, the first introduction flow passage 37a, the housing hole 37b, and the second introduction flow passage 37c. This increases the pressure inside the concave portion 31f, and the regulating member 70 projects in the communication passage 22. When the regulating member 70 thus projects in the communication passage 22, a flow passage area of the communication passage 22 decreases; therefore, a resistance given to the magneto-rheological fluid flowing through the communication passage 22 increases. Accordingly, even if the predetermined damping force cannot be generated by the coil 33a, the damper 100 can obtain the certain damping force in the expansion operation.

With the embodiment, the introduction flow passage 37 is configured to communicate with the first fluid chamber 11. Instead of this, the introduction flow passage 37 may communicate with the second fluid chamber 12. In this case, even if the coil 33a cannot generate the predetermined damping force, the damper 100 can obtain the certain damping force in the contraction operation.

The embodiment includes the one regulating member 70 and the one concave portion 31f; however, the plurality of regulating members 70 and the plurality of concave portions 31f may be disposed. In this case, the one fail valve 60 may perform the control by disposing branch passages from the one introduction flow passages 37 to the concave portions 31f. The introduction flow passages 37 and the fail valves 60 may be disposed for the respective concave portions 31f.

The above-described embodiment provides the following effects.

With the damper 100, in the case where the current applied to the coil 33a is the predetermined value or less, that is, the coil 33a cannot generate the predetermined damping force, the fail valve 60 opens the introduction flow passage 37. In view of this, the expansion or the contraction operation of the damper 100 guides the high-pressure magneto-rheological fluid in the first fluid chamber 11 or the second fluid chamber 12, which communicates with the introduction flow passage 37, into the concave portion 31f. Thus, the regulating member 70 projects into the communication passage 22. This reduces the flow passage area of the communication passage 22; therefore, the flow of the magneto-rheological fluid between the first fluid chamber 11 and the second fluid chamber 12 is restricted. This increases the resistance given to the magneto-rheological fluid flowing through the communication passage 22. Accordingly, even if the coil 33a cannot generate the predetermined damping force, the damper 100 can obtain the certain damping force.

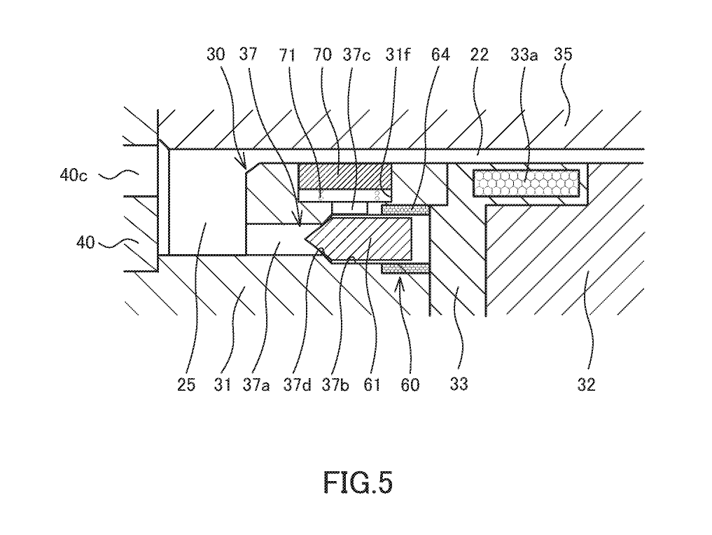

The embodiment uses the coil 33a as means to bias the movable core 62 of the fail valve 60. However, like a modification illustrated in FIG. 5, an electromagnetic coil 64 may be disposed at an outer peripheral part of the valve element 61 separately from the coil 33a. In this case, the coil 33a is coupled to the electromagnetic coil 64 in series. It should be noted that, this eliminates the need for disposing the movable core 62.

Thus, disposing the electromagnetic coil 64 on the outer peripheral part of the valve element 61 separately from the coil 33a allows directly giving the biasing force to the valve element 61. Accordingly, even if a setting value of the predetermined value Ia of the current is reduced, the biasing force to close the valve element 61 can be obtained.

The following summarizes configurations, actions, and effects according to the embodiments of the present invention configured as described above.

The magneto-rheological fluid damper 100 includes the cylinder 10, the piston 20, and the first fluid chamber 11 and the second fluid chamber 12. The cylinder 10 seals the magneto-rheological fluid. The piston 20 is coupled to the piston rod 21. The piston 20 is movably disposed in the cylinder 10. The piston 20 partitions the first fluid chamber 11 and the second fluid chamber 12 in the cylinder 10. The piston 20 includes the piston core 30, the ring body (flux ring 35), the electromagnetic coil (coil 33a), the concave portion 31f, the regulating member 70, the introduction flow passage 37, and the fail valve 60. The piston core 30 is coupled to the piston rod 21. The ring body (flux ring 35) surrounds the outer periphery of the piston core 30. The communication passage 22 is formed between the piston core 30 and the ring body (flux ring 35). The communication passage 22 communicates between the first fluid chamber 11 and the second fluid chamber 12. The electromagnetic coil (coil 33a) generates the magnetic field acting on the magneto-rheological fluid flowing through the communication passage 22. The concave portion 31f is formed on the outer peripheral surface of the piston core 30. The concave portion 31f internally houses the regulating member 70. The introduction flow passage 37 guides the magneto-rheological fluid in the first fluid chamber 11 or the second fluid chamber 12 into the concave portion 31f such that the regulating member 70 projects into the communication passage 22. The fail valve 60 opens and closes the introduction flow passage 37. In the case where the current applied to the electromagnetic coil (coil 33a) is the predetermined value or less, opening the introduction flow passage 37 by the fail valve 60 projects the regulating member 70 to the inside of the communication passage 22.

With this configuration, in the case where the current applied to the electromagnetic coil (coil 33a) is the predetermined value or less, the fail valve 60 opens the introduction flow passage 37. Accordingly, guiding the magneto-rheological fluid from the first fluid chamber 11 or the second fluid chamber 12 to the concave portion 31f projects the regulating member 70 to the inside of the communication passage 22. This restricts the flow of the magneto-rheological fluid between the first fluid chamber 11 and the second fluid chamber 12 by the regulating member 70. Accordingly, even when the current applied to the electromagnetic coil (coil 33a) is the predetermined value or less, the certain damping force can be obtained.

With the magneto-rheological fluid damper 100, the fail valve 60 closes the introduction flow passage 37 by the magnetic force generated by the electromagnetic coil (the coil 33a) disposed at the piston 20.

Since this configuration uses the electromagnetic coil (the coil 33a) disposed at the piston 20 as a driving source of the fail valve 60, the driving source of the fail valve 60 needs not to be additionally disposed.

Embodiments of this invention were described above, but the above embodiments are merely examples of applications of this invention, and the technical scope of this invention is not limited to the specific constitutions of the above embodiments.

The embodiment is described with a lift-type electromagnetic valve as the example of the fail valve 60. However, the fail valve 60 may be a spool-type electromagnetic valve or a similar electromagnetic valve that employs the valve element 61 as a spool.

This application claims priority based on Japanese Patent Application No. 2016-003838 filed with the Japan Patent Office on Jan. 12, 2016, the entire contents of which are incorporated into this specification.

1. A magneto-rheological fluid damper that employs magneto-rheological fluid as working fluid, the magneto-rheological fluid changing viscosity in accordance with a strength of a magnetic field, the magneto-rheological fluid damper comprising:
a cylinder into which the magneto-rheological fluid is sealed;
a piston coupled to a piston rod, the piston being movably disposed in the cylinder; and
a first fluid chamber and a second fluid chamber partitioned in the cylinder by the piston, wherein
the piston includes:
a piston core coupled to the piston rod;
a ring body that surrounds an outer periphery of the piston core, a communication passage being formed between the piston core and the ring body, the communication passage communicating between the first fluid chamber and the second fluid chamber;
an electromagnetic coil configured to generate a magnetic field acting on the magneto-rheological fluid flowing through the communication passage;
a concave portion formed on an outer peripheral surface of the piston core;
a regulating member housed in the concave portion;
an introduction flow passage that guides the magneto-rheological fluid in the first fluid chamber or the second fluid chamber into the concave portion such that the regulating member projects into the communication passage; and
a fail valve that opens and closes the introduction flow passage, wherein
in a case where a current applied to the electromagnetic coil has a predetermined value or less, opening the introduction flow passage by the fail valve projects the regulating member into the communication passage.

2. The magneto-rheological fluid damper according to claim 1, wherein
the fail valve closes the introduction flow passage by a magnetic force generated by the electromagnetic coil disposed at the piston.
